(19) United States
(12) Patent Application Publication
(10) Pub. No.: US 2005/0238260 A1
(43) Pub. Date: Oct. 27, 2005

(54) Image and optical mark scanner with encryption

(76) Inventors: Dave Coleman, Corona, CA (US); Joe Zajac, Cypress, CA (US)

Correspondence Address: FISH & RICHARDSON, PC, 12390 EL CAMINO REAL, SAN DIEGO, CA, 92130-2081, US

(21) Appl. No.: 11/107,626

(22) Filed: Apr. 15, 2005

Related U.S. Application Data
(60) Provisional application No. 60/562,725, filed on Apr. 16, 2004.

(51) Int. Cl. G06K 9/22

(52) U.S. Cl. 382/313

(57) ABSTRACT

A scanner for scanning images and optical marks with optical mark recognition (OMR) and encryption is disclosed. A scanning system may include a scanning head configured to read documents comprising characters, marks, and images. The scanning system may include an encryption algorithm for encrypting the scanned data, a processor to use the encryption algorithm to encrypt the data scanned by the scanning head, and an output port to output the data encrypted by the processor. The scanner may encrypt the scanned data substantially immediately after at least some of the data scanned by the scanning head.

### CROSS REFERENCE TO RELATED APPLICATIONS

This application claims the benefit of priority from U.S. Provisional Application entitled “IMAGE AND OPTICAL MARK SCANNER WITH ENCRYPTION,” filed Apr. 16, 2004 by Dave Coleman and Joe Zajac, application Ser. No. 60/562,725, the disclosure of which is incorporated by reference. This application is cross-related to U.S. application entitled “SCANNER READ HEAD FOR IMAGES AND OPTICAL MARK RECOGNITION,” filed on Apr. 15, 2005 by Dave Coleman and Joe Zajac.

### BACKGROUND

Scanners are used to scan images on physical medium, such as paper, into electronic data files, which are transferred to computers for access, storage and display. When compared to having a scanning operator to manually grade student or survey response forms, using automatic scanning machines to scan preprinted forms saves time. Automatic scanning machines and preprinted forms enable rapid monitoring of items and personnel, and permit more frequent record keeping or testing than might otherwise be achieved if a human operator checked the forms manually. For example, such automatic scanning machines are used for tasks such as scoring scholastic test results, tallying attendance data and tallying inventory. The preprinted scannable forms may have markings to indicate responses from students in a format with rows and columns. The scannable forms may also include response control marks to indicate the positions of the response receiving rows, which can include numeric values or multiple choice letters.

### SUMMARY

A read head system for a scanner to scan images and optical marks from physical medium is disclosed.

In one general aspect, the techniques feature a scanner that includes a scanning head to scan data from a physical medium, an encryption algorithm for encrypting the scanned data, and a processor operable to use the encryption algorithm to encrypt the data scanned by the scanning head. The processor is operable to encrypt the scanned data substantially immediately (e.g., in real time) after at least some of the data scanned by the scanning head. The scanner also includes an output port to output the data encrypted by the processor.

Advantageous implementations can include one or more of the following features. The scanner can include multiple scanning heads including a top scanning head to scan a top side of the physical medium and a bottom scanning head to scan a bottom side of the physical medium. The scanner may include firmware configured to compress the scanned data to generate compressed data. The firmware can be operable to store multiple types of encryption algorithms. The scanner may also include a memory to store the data scanned by the scanning head, an input port to receive the encryption algorithm from a computer, and firmware configured to store the received encryption algorithm. The firmware can be embodied in a field programmable gate array (FGPA).

The encryption algorithm can be based on a Secure Sockets Layer (SSL) Internet security standard, an RSA public key encryption algorithm, or an ARCFOUR encryption algorithm. The scanner can be configured to encrypt the scanned data while scanning at least 60 pages per minute (ppm). The output port can be coupled to a wide area network, a local area network, a personal computer, the Internet, a Peripheral Component Interface (PCI), or a Universal Serial Bus (USB) connector.

In another aspect, a system includes a scanner to scan data from a physical medium, encrypt the scanned data, and output encrypted data. The system has a network coupled to the scanner, in which the network is operable to receive the encrypted data from the scanner and transfer the encrypted data. The system also includes a computer coupled to the network. The computer is operable to receive the encrypted data from the network and decrypt the data. The scanner is configured to encrypt the scanned data substantially immediately (e.g., in real time) after at least some of the physical medium is scanned.

Advantageous implementations can include one or more of the following features.

The scanner can be configured to read and optically recognize marks on the medium. The scanner can use an encryption algorithm stored on the scanner to encrypt the medium. The encryption algorithm can be a Secure Sockets Layer (SSL) Internet security standard, an RSA public key encryption algorithm, or an ARCFOUR encryption algorithm. The scanner may also be operable to compress the scanned data. The network can include a wide area network, a local area network, a wireless network, or the Internet.

The scanner can be configured to execute the encryption algorithm and scan the physical medium concurrently, in which the scanner can scan the physical medium at a rate of at least 60 pages per minute (ppm) while encrypting the scanned data. The system may also have a graphical user interface (GUI) to enable or disable the encryption.

In another aspect, a method involves scanning data from a document with a scanner, and using an encryption algorithm stored on the scanner to encrypt the scanned data in the scanner. The scanner is configured to encrypt the scanned data substantially immediately after at least some data from the document is scanned. The method also involves outputting the encrypted data from the scanner via an output port on the scanner.

Advantageous implementations can include one or more of the following features. The method may involve storing the scanned data in a memory in the scanner. In scanning the data, the scanner can recognize and read optical marks on the medium. The method may involve using a computer coupled to the scanner to select an option on the scanner to encrypt the scanned data.

In another aspect, a scanning system includes a scanning head configured to read documents including characters, marks, and images, and circuitry to switch between an image scanning mode and an optical mark recognition (OMR) mode. The scanning system includes a processor to process data scanned from the scanning head in either the image scanning mode or the optical mark recognition mode, and at least one output port for the processed data.

Advantageous implementations can include one or more of the following features. The circuitry can include firmware configured to switch between an image scanning mode and an optical mark recognition (OMR) mode. The scanning head can be configured to scan one side of each document. The scanning system can be configured to scan a double-sided document, in which the scanning system includes another scanning head to scan an opposite side of the double-sided document. The processor can be configured to process scanned data from both sides of the double-sided document. The circuitry can be configured to automatically recognize whether the scanned data are for the image scanning mode or the optical mark recognition mode. The scanning system can recognize scanned data for the optical mark recognition mode by recognizing scanned data for any one of a start-of-form mark, a response control mark, and an end-of-form mark on each scanned document.

The scanning system may include a graphical user interface (GUI) to facilitate switching between the image scanning mode and the optical mark recognition mode. The scanning system can have a first user-selectable option to scan in a manual mode or in an automatic mode. The automatic mode automatically can determine whether scanning is performed in the image scanning mode or the optical mark recognition mode. The manual mode can provide a second user-selectable option, in which the second user-selectable option is configured for manual switching between the image scanning mode and the optical mark recognition mode.

The scanning head can include a light-emitting diode lighting bar, a rod lens, and a circuit board with sensing devices. The scanning system may have a first-in-first-out (FIFO) memory to receive scanned data from the scanning head, a field programmable gate array (FPGA) with data compression functionality to compress scanned data from the FIFO, and a system bus configured to send scanned data from the FIFO to the FPGA. The system bus is further configured to send compressed data from the FPGA to the processor.

In another aspect, a scanning method involves scanning a document, and automatically determining a scanning mode for the document. The scanning mode includes an image scanning mode or an optical mark recognition mode. In automatically determining the scanning mode, the method involves using the optical mark recognition mode when recognizing data for a start-of-form mark on the document, and using the image scanning mode when not recognizing data for the start-of-form mark on the document.

Advantageous implementations can include one or more of the following features.

The scanning mode can include a firmware scanning mode for the document, in which the firmware scanning mode may include the image scanning mode or the optical mark recognition mode in firmware. The scanning method may also include providing an option for a manual scanning mode or an automatic firmware scanning mode. The automatic firmware scanning mode can include automatic triggering of the image scanning mode or the optical mark recognition mode. The manual scanning mode can include a manual selection option to manually select the image scanning mode or the optical mark recognition mode. The scanning of the document may involve scanning a double-sided document.

In another aspect, an apparatus for scanning a document includes a scanning head with contact image sensors. The scanning head is configured to read images and marks on the document. The apparatus includes a processor configured to process scanned images and marks. The processor is further configured to perform optical mark recognition (OMR) on the marks. The apparatus also includes a field programmable gate array (FPGA) with a compression algorithm to compress scanned data prior to sending the scanned data to the processor.

Advantageous implementations can include one or more of the following features.

The apparatus may also include a second scanning head to scan a side of the document opposite of a side for the first scanning head, in which the apparatus can be configured to scan single-sided documents and double-sided documents. The processor can be configured to process scanned data for single-sided and double-sided documents. The apparatus can be configured to automatically determine whether scanning is performed in an image scanning mode or an optical mark recognition mode.

The scanner may be coupled to a computer and/or a network, such as a local area network or the Internet, and may encrypt the scanned data. The disclosed scanning system may provide a number of advantages. For example, the scanning system may have hardware and software configured such that a single scanning head can both read images and perform optical mark recognition (OMR) from a form or document. Alternatively, the scanning system may have two scanning heads for double-sided forms or documents, in which each scanning head reads one side of the form. The scanning system scans double-sided forms with a single pass of the form across the scanning heads, in which both images can be scanned and OMR performed in a single pass.

In one advantage, the ability to both read images and perform OMR on one side of a form with a single scanning head reduces the amount of hardware and software resources required for the system. In some implementations, one or both sides of the form can be read with a scanning head used for each side of the form, and a single processor on a scanner board can process the scanned data.

In another advantage, the scanning system can scan one or more of the following: a numeric value block, a plurality of response control marks, response receiving rows, a bar code, markings in ink and/or pencil, images, optical character recognition (OCR) spaces and/or intelligence character recognition (ICR) spaces.

The scanner can scan a form and automatically determine if the scanned data corresponds to images or text or other marks for OMR. A user of a computer coupled to the scanner can use a graphical user interface (GUI) to select whether to activate or deactivate any of the following: manual scanning of images; manual scanning of OMR; or the user may select to allow the scanner to automatically determine whether it is scanning images or OMR markings.

In another implementation, a scanner includes a scanning head to scan data from a medium, a processor to execute a process to encrypt data scanned by from the scanning head, and an output port to output the data encrypted by the processor. For example, encrypting data at the scanner allows scanned electronic data files to be securely transmitted over public networks such as the Internet. The scanner with encryption may protect confidential data, such as hospital records, physician/patient records, tax returns, shipping receipts, invoices, and/or other company records before the data is sent to a user computer.

In another advantage, the scanner can scan data for one or more forms and encrypt the data in real time. In other words, the scanner can begin scanning a document and substantially immediately as the data from the scanned document is digitized, the scanned data can be encrypted by a processor in the scanner. A user of a computer coupled to the scanner can select whether to activate or deactivate the scanner encryption.

The details of one or more aspects are set forth in the accompanying drawings and the description below. Other features and advantages will be apparent from the description and drawings, and from the claims.

### BRIEF DESCRIPTION OF DRAWINGS

FIG. 1 shows an exemplary scannable form having a horizontal format.

FIG. 2 shows a perspective view of an exemplary form scanning apparatus.

FIG. 3A illustrates an exemplary system with a scanner, computers, and a network.

FIG. 3B illustrates an exemplary system with a scanner that has an encryption application.

FIG. 3C illustrates an exemplary system with several scanners with encryption coupled to a network.

FIG. 4 shows an exemplary flow diagram of operating the scanner in FIG. 3A.

FIG. 5 shows an exemplary detailed flow diagram of operating the scanner in FIG. 3A.

FIG. 6A illustrates components of the scanner shown in FIG. 3A.

FIG. 6B shows an exemplary block diagram of the scanner processor board design in FIG. 6A and input/output connections.

FIGS. 7A-7B show exemplary block diagrams of the scanner processor board design and associated components.

FIG. 8 shows an exemplary contact sensor image head that can be implemented in the scanner of FIG. 3A.

Like reference symbols in the various drawings indicate like elements.

### DETAILED DESCRIPTION

The following description is not to be taken in a limiting sense, but is made for the purpose of illustrating one or more uses of a scanner. For instance, a scanning system may have hardware and software so that a single scanning head can both scan images and perform optical mark recognition (OMR) from one side of a form or document. Alternatively, the scanning system may have two scanning heads for double-sided forms or documents, in which each scanning head reads one side of the form. The scanning system can scan double-sided forms with a single pass of the form across the scanning heads, in which both images and OMR can be scanned in the single pass.

The scanning system has the ability to read both images and OMR on one side of a form with a single scanning head that can reduce the amount of hardware and software resources required for the system. In some exemplary implementations, a single processor and a single scanning head can be used to read one side of a form for both OMR and images. In conventional systems, two or more scanning heads and two or more processors are required, in which a first scanning head and a first processor is used in scanning and processing images, and a second scanning head and a second processor is used in scanning and processing OMR.

In some implementations, the scanning system may encrypt data scanned by the scanning head and store the encrypted data and/or send the encrypted data out of an output port of the scanner. The scanner may include processing capabilities to encrypt the scanned data in real time.

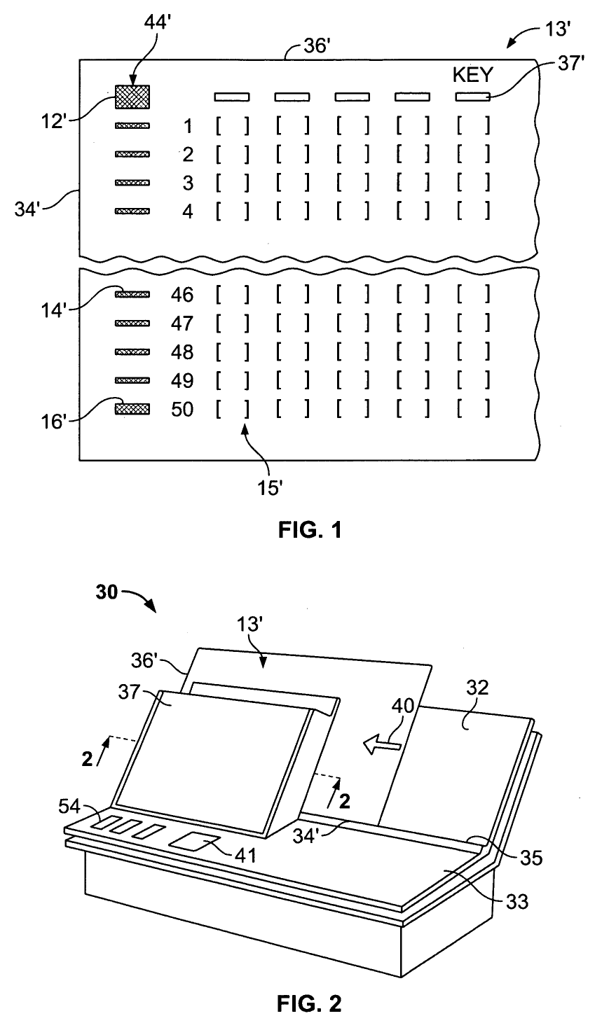

FIG. 1 shows an exemplary scannable form 13′ having a horizontal format marketed by Scantron Corporation of Irvine, Calif. As shown in FIG. 1, the exemplary Scantron-type scannable form has a start-of-form mark 12′, multiple response control marks 14′, and an end-of-form mark 16′. These marks 12′, 14′and 16′ are aligned in a control mark column 44′ which is parallel to the longitudinal form edge 34′ of the form 13′. Detection of the start-of-form mark 12′ by the form scanning apparatus 30 (FIG. 2) automatically initiates scanning of the form 13′. Each of the response control marks 14′ is row aligned with one or more response spaces 15′. Responses are indicated by marking an opaque mark within a response space 15′.

If a test is being scored, for example, detection of a response control mark 14′ enables appropriate circuitry to compare a response entered in a response receiving space 15′ aligned with that response control mark 14′ with corresponding correct answer data stored in a memory. In other applications, responses entered in response spaces 15′ are tallied. The end-of-form mark 16′, the last mark in the control mark column 44′, enables score or tally printout, or triggers data storage or transmission. Both the start-of-form mark 12′ and the end-to-form mark 16′ can act as response control marks. The present disclosure is not limited to use with forms having a start-of-form mark 12′ and/or an end-of-form mark 16′.

FIG. 2 shows a form scanning apparatus 30 designed to scan a scannable form, such as scannable form 13′ in FIG. 1. The form may have a horizontal format or a vertical format. As shown in FIG. 2, the conventional form 13′ is placed face-up on a vertically inclined platen 32 provided on the apparatus housing 33. A longitudinal edge 34′ of the form 13′ rests on a ledge 35 at the bottom of the platen 32. The form leading edge 36′ is inserted behind a reader housing 37 containing a pair of drive wheels (not shown), rotated by a motor (not shown), which transports the form 13′ at a predetermined rate in the direction of the arrow 40. As the form 13′ is driven beneath the housing 37, each response is detected and marked. The total number of responses may appear on a display 41 and optionally may be printed on the form 13′. When the form 13 is used to score tests, the number of correct responses may be displayed and printed. Alternatively, the tallied responses may be recorded in electronic form for further processing by another machine, or transmitted (e.g., by modem) to a central computer.

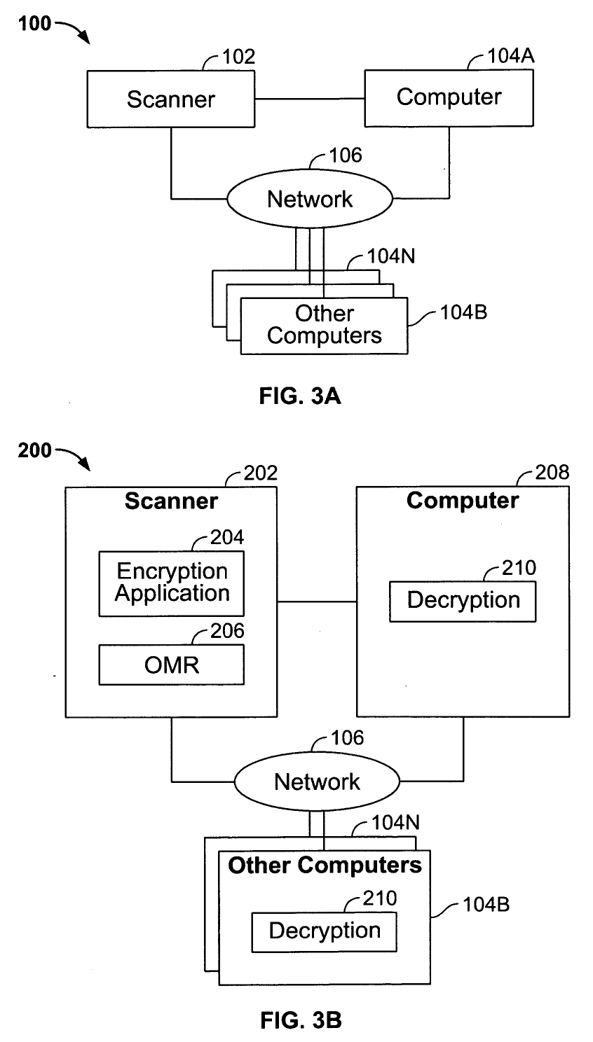

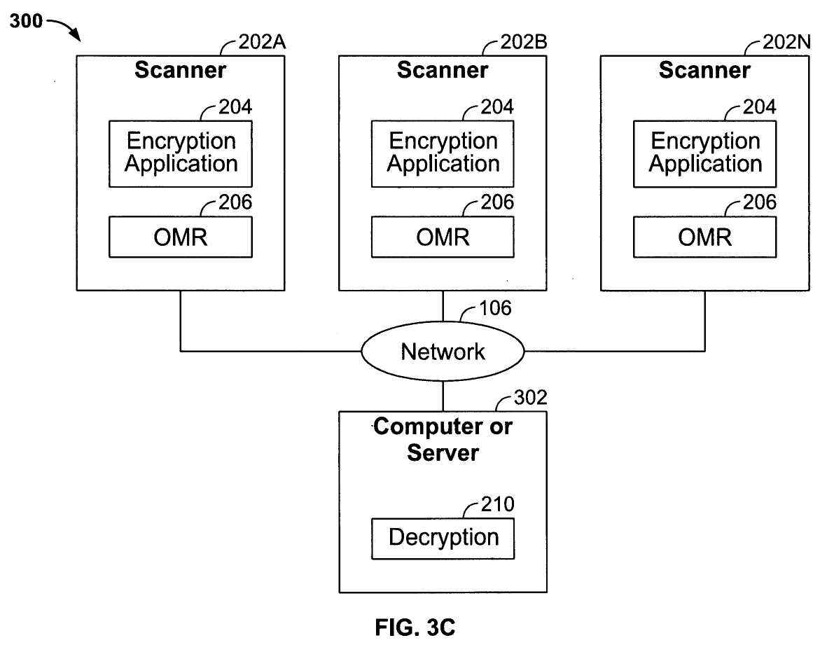

FIG. 3A illustrates a system 100 with a scanner 102 coupled to a computer 104A and a network 106. The network 106 may be coupled to other computers 104B-104N. The scanner 102 may be a scanner made by Scantron Corporation of Irvine, Calif., or another type of scanner. The computers 104A-104N may be desktop personal computers (PCs), laptops, handheld computers, servers, or other types of computers or devices with microprocessors. The network 106 may be the Internet, an Ethernet, a wide area network (WAN), a local area network (LAN), a wireless network, a cellular network, or another type of network.

The scanner 102 can scan text and images on a physical medium such as paper into an electronic data file, which may be sent to the computer 104A or the network 106. The computers 104A-104N may store, access and display the electronic data file from the scanner 102. The computers 104A-104N may have software to provide optical mark recognition (OMR) and/or optical character recognition (OCR) from the electronic data files. The computer 104A may transmit scanned electronic data files through the network 106 to other computers 104B-104N.

The scanned electronic data files may contain confidential information, such as hospital records, physician/patient records, tax returns, shipping receipts, invoices, company records, etc. The computer 104A may use encryption software to encrypt the electronic data files before sending them to other computers 104B-104N via the network 106. Alternatively, the scanner 102 may directly transmit an electronic data file to the computers 104B-104N via the network 106. The network 106 may be non-secure and open to public access. Other computers coupled to the network 106 may be able to intercept or access electronic data files from the scanner 102 or computers 104A-104N without user authorization. Potentially, spyware, viruses or other unauthorized software on the computer 104A itself may access or copy electronic files from the computer 104A without authorization before the computer 104A has a chance to encrypt the data files.

FIG. 3B illustrates a system 200 with a scanner 202 that has an encryption application or process 204 that encrypts data files during scanning before sending the data files to the computer 208 or the network 106. The scanner 202 can scan images as well as optical marks with the same scanning head. The encryption can be implemented in the firmware of the scanner 202. An OMR module 206 in the scanner 202 can recognize marks on a scanned document, such as a Scantron™ form with multiple circles and squares used for tests and surveys. The computers 208, 104B-104N have decryption software 210 to decrypt encrypted data files from the scanner 202.

In some implementations, one or more of the computers coupled to the scanner may control the encryption functionality of the scanner. For example, one or more of the computers may have software for a graphical user interface (GUI) user to select an option to activate or deactivate encryption functionality on the scanner. In these exemplary implementations, a GUI user on a computer coupled to the scanner can select the option to determine whether the computer receives encrypted scanned data or unencrypted scanned data from the scanner.

FIG. 3C illustrates a system 300 with several scanners 202A-202N, which have encryption applications 204, coupled to a network 106. The network 106 is coupled to a file management system computer or server 302, which stores and manages a large number of documents, such as hospital records, physician/patient records, tax returns, shipping receipts, financial records, test scores, invoices, company records, etc. The scanners 202A-202N may be located at remote locations or different offices. For example, a packaging and shipping company may have scanners in multiple locations around the world to scan documents such as invoices and receipts. With the encryption applications 204, the scanners 202A-202N may securely transmit files across the network 106, such as the Internet, to a computer or server 302 at a company headquarters or central location.

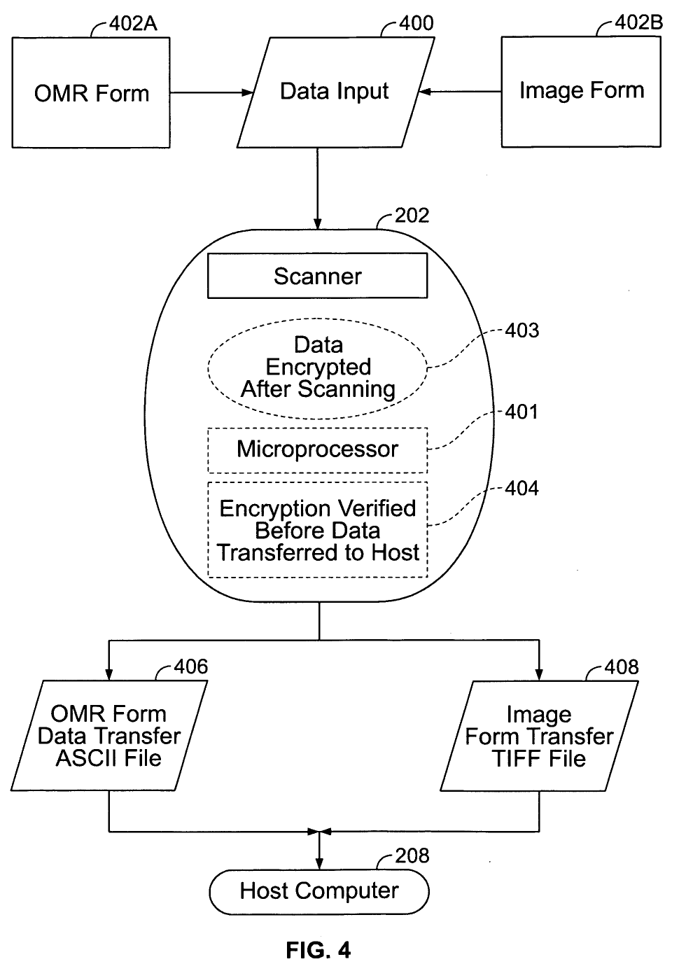

FIG. 4 shows a flow diagram of operating the scanner 202 shown in FIG. 3B. The scanner 202 may receive data input 400, such as image documents/forms 402B and OMR forms 402A, which may be provided by Scantron Corporation. The scanner 202 has an embedded microprocessor 401 on a microprocessor board that encrypts data after scanning 403 and verifies encryption 404 before transferring data to the host computer 208. OMR data transferred to the host computer 208 may be in an ASCII file format, and image data transferred to the host computer 208 may be in a TIFF file format.

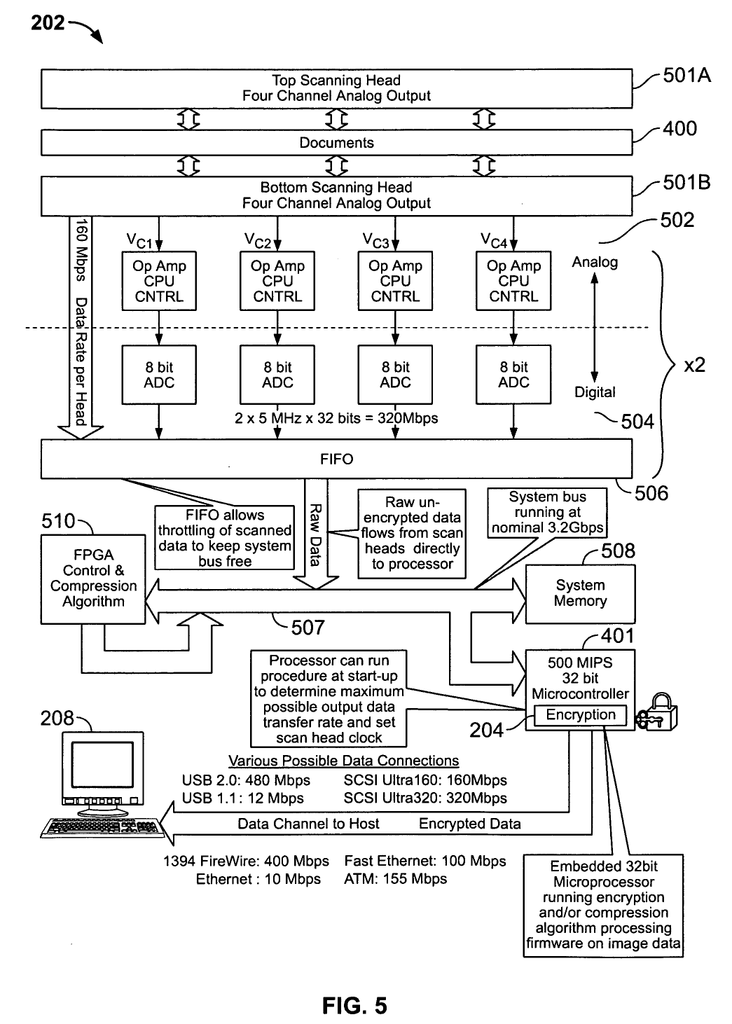

FIG. 5 shows another flow diagram of operating the scanner 202 shown in FIG. 3B, which includes top and bottom scanning heads 501A-501B, operational amplifiers (op amps) 502, analog-to-digital converters (ADCs) 504, a first-in-first-out (FIFO) memory 506, a system memory 508, a field programmable gate array (FPGA) 510, and the embedded microprocessor 401. The top and bottom scanning heads 501A-501B may each scan data, for example, at about 5 MHz or more and have four-channel analog outputs. The FIFO 506 may be, for example, a 36 bit×4 k FIFO. The FPGA 510 may be, for example, a Spartan 3 FPGA made by Xilinx. The system memory 508 may be, for example, a 128 MB SDRAM. A system bus 507 between the FIFO 506, FPGA 510, system memory 508 and microprocessor 401 may be, for example, a Motorola 60x bus with 32-bit addresses and 32-bit data running at 66 MHz and 3.2 Gbits per second. The microprocessor 401 may be, for example, a Motorola MPC 8257 or MPC8250 processor, which can process about 500 million instructions per second (MIPS) and run an encryption algorithm. The scanner design is not limited to the components described herein, but other types of scanning heads, FIFOs, FPGAs, memories, buses, and microprocessors may be used in the scanner 202.

In operation, the top and bottom scanning heads 501A-501B in FIG. 5 can scan images and optical marks on single-sided or double-sided documents in a single pass of the document across the scanning heads 501A-501B. The top and bottom scanning heads 501A-501B may include contact image sensors (CIS) that sense and read images as well as marks on the document for the microprocessor 401 to perform optical mark recognition (OMR). The op amps 502 amplify analog data signals from the scanning heads 501A-501B, and the ADCs 504 convert analog data signals to digital data signals. The FIFO 506 stores digital data from the ADCs 504 and allows throttling of scanned data to keep the system bus 507 free. The FIFO 506 sends raw data (i.e., scanned, but unencrypted and uncompressed data) to the FPGA 510, the system memory 508, and the microprocessor 401 via the system bus 507. The FPGA 510 may execute a compression algorithm to compress the raw data from the FIFO 506 to facilitate data storage or data transmission. The system memory 508 may store raw data from the FIFO 506 and/or compressed data from the FPGA 510.

The microprocessor 401 executes the encryption application 204 of FIG. 3B to encrypt raw data from the FIFO 506 and/or compressed data from the FPGA 510. In one configuration, the microprocessor 401 can encrypt data on-the-fly substantially immediately after at least some data is scanned from a form. In some configurations, the microprocessor 401 may also run a compression application to compress the data.

The encryption application 204 may be based on the Secure Sockets Layer (SSL) Internet security standard and an encryption algorithm, such as the RSA public key encryption algorithm or ARCFOUR. Both the SSL standard and the RSA encryption algorithm were developed by RSA Data Security, Inc. ARCFOUR is a stream encryption algorithm used in network security systems. ARCFOUR was designed by Ron Rivest of RSA Data Security, and is known as “Rivest Cipher 4” or “Ron's Code.” Advantages of using ARCFOUR include an adjustable key size and a low amount of processing resources required to perform the encryption. In some implementations, ARCFOUR can be used in the scanner to allow at least 60 pages per minute (ppm) of scanning. Implementing the scanner with ARCFOUR can allow 128-bit protection against hacking, and can allow execution of the encryption algorithm in real-time with the scanning process. Alternatively, the processor 401 may use other types of encryption.

In some configurations, the encryption may be configured to a specific software application on the computer 208, which processes the image or OMR data for storage, display, transfer, etc. In other words, the encryption is application-specific and not user-specific, e.g., the encryption does not depend on a specific user or the user's name and password. In one configuration, the encryption and decryption processes do not use a password.

In some configurations, a user at the scanner 202 or computer 208 may select a type of encryption from a number of different encryption types stored at the scanner 202 or computer 208. Alternatively, the scanner 202 or computer 208 may provide an interface for a user to load an encryption application from another computer or go and find an encryption application via the Internet.

In one configuration, a user at the scanner 202 or computer 208 may enable and disable the encryption. In another configuration, the type of encryption used is not visible to a user of the scanner 202. The encryption algorithm may be implemented in the firmware of the scanning system. For example, the encryption algorithm may be implemented in software that is embedded in the hardware of the scanning system. The firmware can allow reading and executing of the encryption algorithm, but not modification of the encryption algorithm. The encryption algorithm may be located in a digital hardware device and/or memory, such as the FGPA 510 and/or the system memory 508. In some implementations, the encryption features of the scanner may be selected by one or more users using a graphical user interface (GUI) displayed on computers coupled with the scanner.

The firmware may automatically recognize if scanned documents are to be treated as OMR marks or as images. For example, the scanning system can recognize the start-of-form mark 12′, multiple response control marks 14′, and an end-of-form mark 16′ of the scan form (FIG. 1). Detection of the start-of-form mark 12′ (FIG. 1) by the form scanning apparatus 30 (FIG. 2) can automatically initiate OMR scanning of the form 13′ (FIG. 1). Alternatively, the scanning system may provide an option to allow the scanner user to determine if the scanner is to operate in OMR mode or image mode. The scanning mode option may be implemented as a button or switch on the scanner, or may be implemented as a selection choice in a graphical user interface on the scanner or on a computer coupled to the scanner. In another example, the scanning mode option may allow the scanner to operate in automatic mode or manual mode. In automatic mode, the firmware in the scanner can automatically determine if the document is for OMR scanning or image scanning. In manual mode, the scanner can allow the user to determine whether the scanner should operate in OMR scanning mode or image scanning mode.

The microprocessor 401 sends encrypted data to the computer 208 via a data channel, such as a Universal Serial Bus (USB) 2.0 at 480 Mbps, USB 1.1 at 12 Mbps, Small Computer System Interface (SCSI) Ultra 160 at 160 Mbps, SCSI Ultra 320 at 320 Mbps, 1394 FireWire at 400 Mbps, an Ethernet at 10 Mbps, a Fast Ethernet at 100 Mbps or an Asynchronous Transfer Mode (ATM) connection at 155 Mbps.

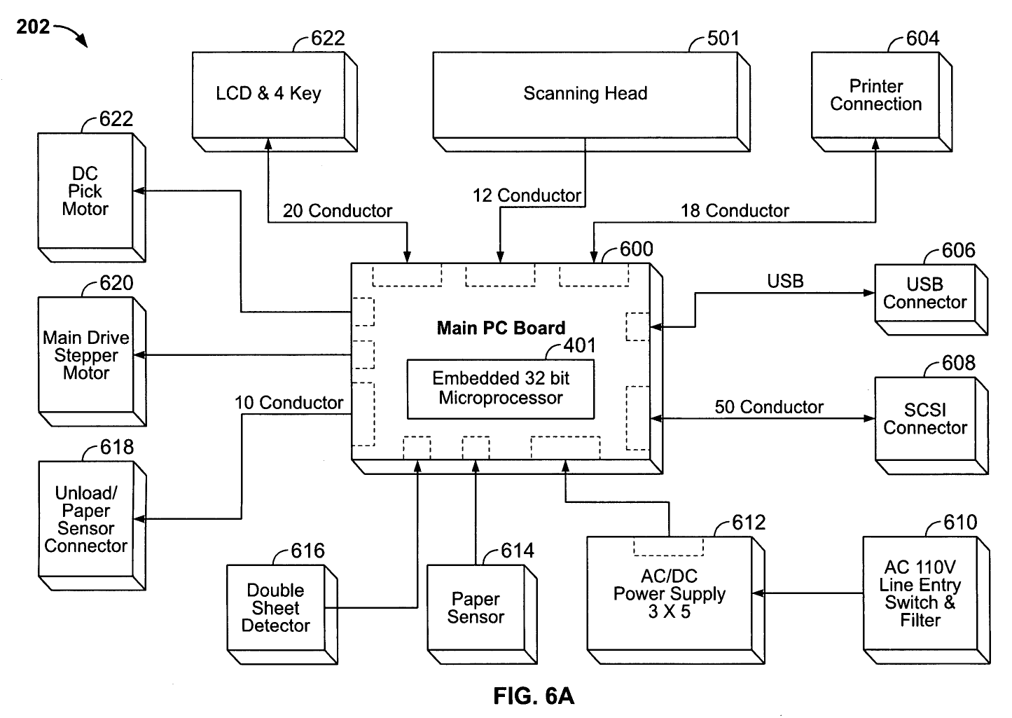

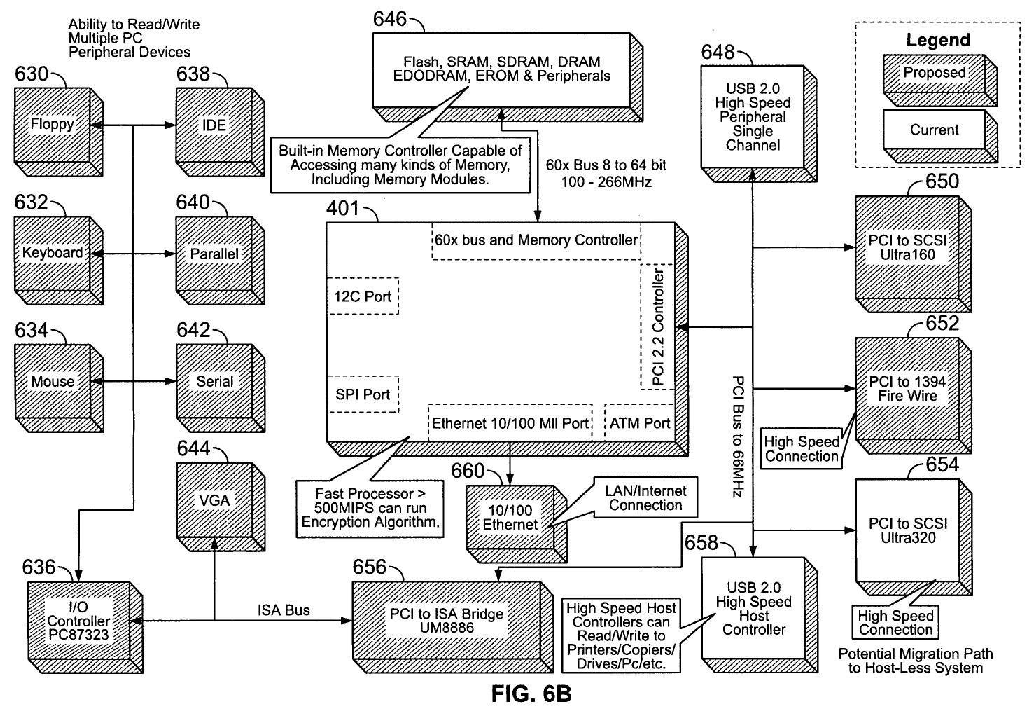

FIG. 6A illustrates components of the scanner 202 in FIG. 2, which include a scanner printed circuit (PC) board 600, a scanning head 501, a printer connection 604, a Universal Serial Bus (USB) connector 606, a Small Computer System Interface (SCSI) connector 608, an alternating current line entry switch and filter 610, a power supply 612, a paper sensor 614, a double sheet detector 616, an unload/paper sensor connector 618, a main drive stepper motor 620, a direct current pick motor 622, a liquid crystal display (LCD) and keypad 622. The main printed circuit board 600 may have an embedded 32-bit microprocessor 401.

FIG. 6B illustrates the microprocessor 401 in FIG. 6A and input/output connections, such as an input/output controller 636, a floppy disk 630, a keyboard 632, a mouse 634, an IDE hard disk drive interface 638, a parallel interface 640, a serial interface 642, a video graphics array (VGA) interface 644, a Peripheral Component Interface (PCI) to Industry Standard Architecture (ISA) bridge 656, an Ethernet LAN or Internet interface 660, memory and peripherals 646, a USB peripheral channel 648, a PCI-to-SCSI interface 650, a PCI-to-1394 Fire wire 652, another PCI-to-SCSI interface 654, and a USB host controller 658. The memory 646 may include flash, static random access memory (SRAM), synchronous dynamic random access memory (SDRAM), dynamic random access memory (DRAM), EDODRAM, and erasable read only memory (EROM). As shown in FIGS. 6A-6B, the scanner 202 can have several types of output ports and interfaces to send scanned, encrypted data to a variety of destinations, such as computers and networks.

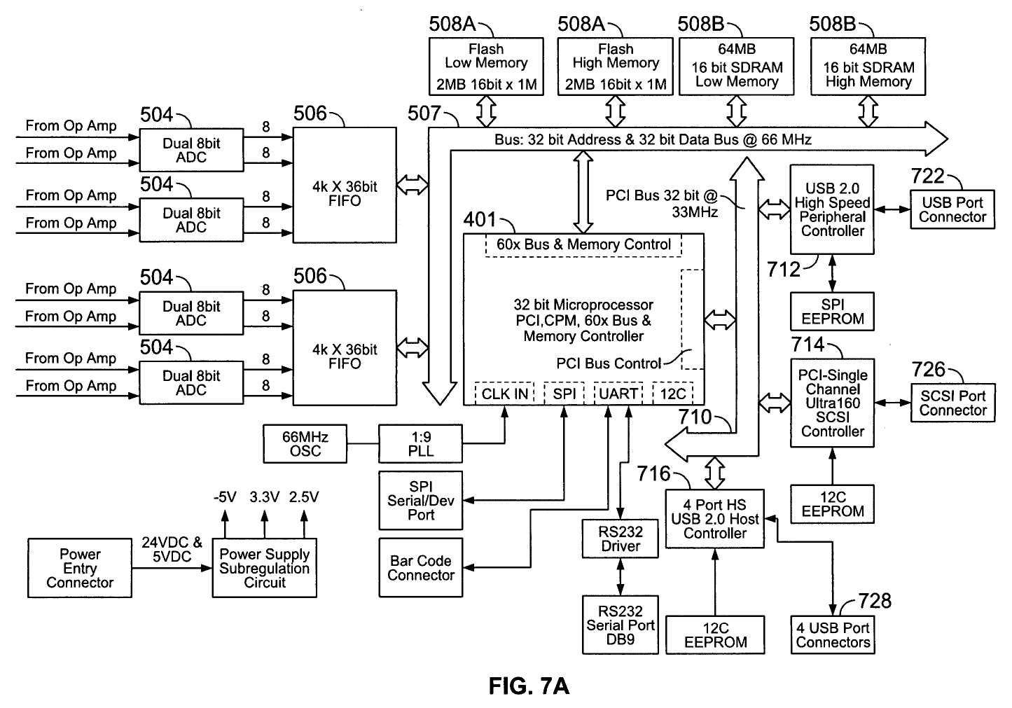

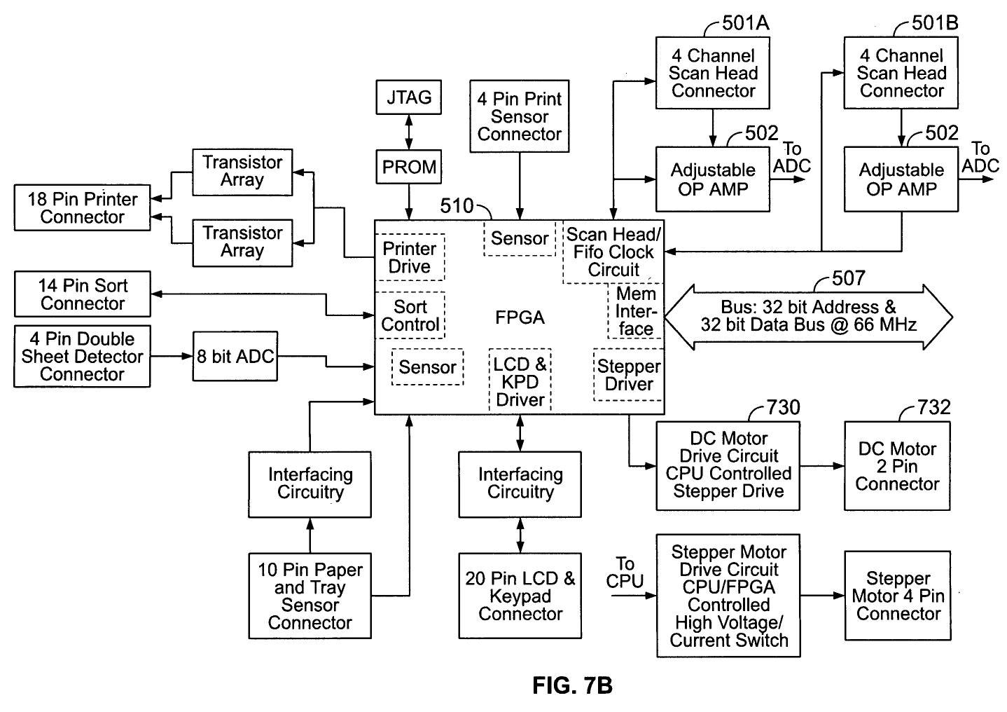

FIGS. 7A-7B show other exemplary diagrams of the scanner processor PC board in FIGS. 6A-6B and associated components. FIG. 7A shows a microprocessor 401 that is capable of processing data received from the scanning head (not shown) using multiple ADCs 504 and a FIFO buffer 506. A system bus 507 transmits data on the main processor board between one or more memory units, such as flash memory 508A and SDRAM memory 508B, the microprocessor 401, and data sent from the scanning head. The microprocessor 401 connects to a PCI-type bus 710 to connect to output controllers, such as a USB peripheral controller 712, a SCSI controller 714, and a USB host controller 716, and their respective output port connectors, such as a USB port connector 711, a SCSI port connector 726, and a USB 4-port connector 728.

FIG. 7B shows an exemplary implementation of the processor PC board of the scanner with a FGPA 510. FIG. 7B shows that the top and bottom scanning heads 501A, 501B of the scanner has four-channel analog outputs that are sent to adjustable op amps 502 to amplify the analog signals to be digitized by the ADCs 504 shown in FIG. 7A. The FGPA 510 receives raw data from the FIFOs 506 shown in FIG. 7A via the system bus 507. The FGPA 510 may use an encryption algorithm to convert the raw data into compressed or encrypted data and either store the compressed data, or send the compressed data to another unit, such as the microprocessor, a memory unit, or an output controller. In some implementations, the FGPA 510 includes an encryption algorithm to encrypt or compress the raw data. The FGPA 510 may use the encryption algorithm to encrypt the data. In other implementations, the microprocessor 401 may use the encryption algorithm from the FGPA 510 to encrypt the data.

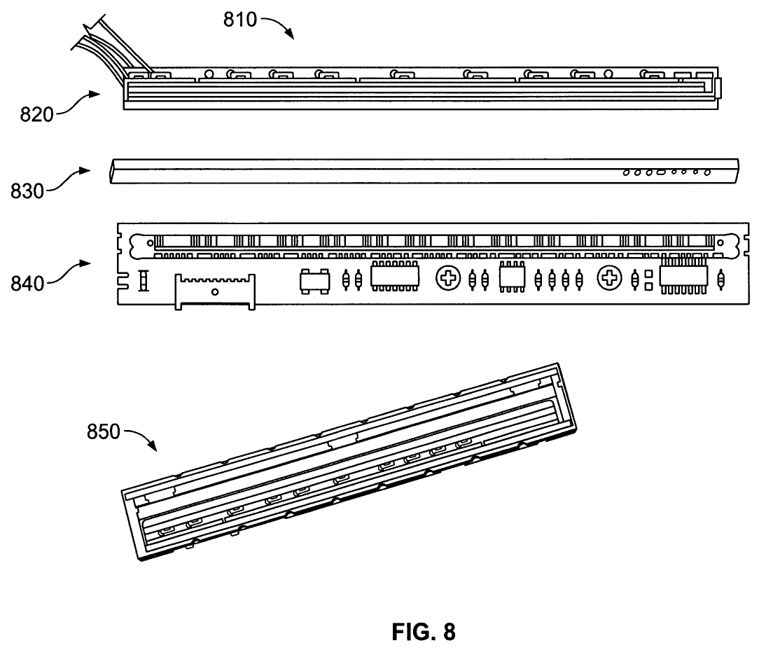

FIG. 8 shows a contact image sensor (CIS) scanning head 810. The scanning head 810 has a light-emitting diode (LED) bar 820 that emits light onto a form or document. The scanning head includes a rod lens 830 for imaging, and a contact image sensor (CIS) circuit board 840 to connect multiple components for imaging, such as discrete, solid-state devices. The complete CIS module 850 includes the CIS scanning head 810, and one or more wiring connections to the main PC board shown in FIG. 6A.

A number of aspects have been described. Nevertheless, it will be understood that various modifications may be made. Accordingly, other aspects are within the scope of the following claims.

1. A scanner comprising:
a scanning head to scan data from a physical medium;
an encryption algorithm for encrypting the scanned data;
a processor operable to use the encryption algorithm to encrypt the data scanned by the scanning head, wherein the processor is operable to encrypt the scanned data substantially immediately after at least some of the data scanned by the scanning head; and
an output port to output the data encrypted by the processor.

2. The scanner of claim 1 wherein the scanning head comprises a plurality of scanning heads including a top scanning head to scan a top side of the physical medium and a bottom scanning head to scan a bottom side of the physical medium.

3. The scanner of claim 1 further comprising firmware configured to compress the scanned data to generate compressed data, and wherein the firmware is operable to store multiple types of encryption algorithms.

4. The scanner of claim 1 further comprising:
a memory to store the data scanned by the scanning head;
an input port to receive the encryption algorithm from a computer; and
firmware configured to store the received encryption algorithm.

5. The scanner of claim 4 wherein the firmware is embodied in a field programmable gate array (FGPA).

6. The scanner of claim 1 wherein the encryption algorithm is based on any of a Secure Sockets Layer (SSL) Internet security standard, an RSA public key encryption algorithm, or an ARCFOUR encryption algorithm.

7. The scanner of claim 1 wherein the scanner is configured to encrypt the scanned data while scanning at least 60 pages per minute (ppm).

8. The scanner of claim 1 wherein the output port is coupled to any of a wide area network, a local area network, a personal computer, the Internet, a Peripheral Component Interface (PCI), or a Universal Serial Bus (USB) connector.

9. A system comprising:
a scanner to scan data from a physical medium, encrypt the scanned data, and output encrypted data;
a network coupled to the scanner, the network being operable to receive the encrypted data from the scanner and transfer the encrypted data; and
a computer coupled to the network, the computer being operable to receive the encrypted data from the network and decrypt the data, wherein the scanner is configured to encrypt the scanned data substantially immediately after at least some of the physical medium is scanned.

10. The system of claim 9 wherein the scanner is configured to read and optically recognize marks on the medium.

11. The system of claim 9 wherein the scanner is operable to use an encryption algorithm stored on the scanner to encrypt the medium.

12. The system of claim 11 wherein the encryption algorithm comprises any of is a Secure Sockets Layer (SSL) Internet security standard, an RSA public key encryption algorithm, or an ARCFOUR encryption algorithm.

13. The system of claim 9 wherein the scanner is operable to compress the scanned data.

14. The system of claim 9 wherein the network comprises any of a wide area network, a local area network, a wireless network, or the Internet.

15. The system of claim 9 wherein the scanner is configured to execute the encryption algorithm and scan the physical medium concurrently, wherein the scanner is configured to scan the physical medium at a rate of at least 60 pages per minute (ppm) while encrypting the scanned data.

16. The system of claim 9, further comprising a graphical user interface (GUI) to enable or disable the encryption.

17. A method comprising:
scanning data from a document with a scanner;
using an encryption algorithm stored on the scanner to encrypt the scanned data in the scanner, wherein the scanner is configured to encrypt the scanned data substantially immediately after at least some data from the document is scanned; and
outputting the encrypted data from the scanner via an output port on the scanner.

18. The method of claim 17 further comprising storing the scanned data in a memory in the scanner.

19. The method of claim 17 wherein scanning the data comprises recognizing and reading optical marks on the medium.

20. The method of claim 17 further comprising using a computer coupled to the scanner to select an option on the scanner to encrypt the scanned data.
